(19) United States
(12) Patent Application Publication
(10) Pub. No.: US 2013/0265803 A1
(43) Pub. Date: Oct. 10, 2013

(54) Light Guide Plate and Backlight Module

(71) Applicant: Jianfa Huang, Shenzhen (CN)

(72) Inventor: Jianfa Huang, Shenzhen (CN)

(73) Assignee: Shenzhen China Star Optpelectronics Technology Co., Ltd., Shenzhen (CN)

(21) Appl. No.: 13/510,898

(22) PCT Filed: Apr. 11, 2012
(86) PCT No.: PCT/CN12/73781

§ 371 Date: May 18, 2012

(30) Foreign Application Priority Data
Apr. 6, 2012 (CN) 201210099834.3

(51) Int. Cl. F21V 13/02

(52) U.S. Cl. 362/608

(57) ABSTRACT

Disclosed are a light guide plate and backlight module. The light guide plate comprises a bottom surface and a top surface opposite to the bottom surface. A plurality of micro-structure units are set up adjacently at the top surface or/and bottom surface of lateral side of the light guide plate. Each micro-structure unit comprises a plurality of branches of micro-structures, and a plurality of micro-structures in each micro-structure unit extend diffusely at the top surface or/and bottom surface of the light guide plate. It is capable of mixing light sufficiently in a shorter distance via the establishment of the light guide plate to attribute the light intensity of the side-light type backlight module even to avoid shadow without raising a frame thickness.

### BACKGROUND OF THE INVENTION

1. Field of the Invention

The present invention relates to a liquid crystal display technology, and more particularly, to a light guide plate and a backlight module.

2. Description of Prior Art

Referring to FIG. 1, FIG. 1 shows a diagram of side-light type backlight module in the prior art. Light radiated from a light emitting diode (LED) light source 101 enters a light guide plate 103 whose a plurality of nets 102. The nets 102, comprising phosphor powder and scattering particles, divert the light from the LED light source 101 even. The diverting effect of nets, however, is worse. Furthermore, the refractivity of light guide plate 103 (about 1.42) is larger than that of air. Therefore, the refracted angle from the LED light source 101 entering the light guide plate 103 turns smaller. Referring to FIG. 2, FIG. 2 shows a schematic diagram of a conventional side-light type backlight module. The refracted angle from a LCD light source 201 turns smaller to attribute light to concentrating to the center more as the light enters a light guide plate 202. In hence, the light intensity around the LED light source 201 is not even, and that's the so called “shadow”. To prevent from shadow, traditionally, it used to enlarge a thickness of a frame to cover the shadow. But enlarging the thickness of the frame needs more material and raises cost.

### SUMMARY OF THE INVENTION

Therefore, an object of the present invention is to provide a kind of light guide plate and a backlight module to make light intensity of a side-light type backlight module even to avoid shadow without enlarging a frame thickness.

According to the present invention, a light guide plate comprising a bottom surface and a top surface opposite to the bottom surface is provided. A plurarity of micro-structure units are set up at the bottom surface or the top surface adjacent to an incident side of the light guide plate. Each micro-structure comprises a plurality of micro-structures. A width of each micro-structure is between 50 μm and 300 μm. Each micro-structure unit comprises a plurality of micro-structures extending divergingly at the bottom surface or the top surface of the light guide plate. Each micro-structure unit comprises a first micro-structure and a plurality of second micro-structures which are set up at two sides of the first micro-structure.

In one aspect of the present invention, the first micro-structure and the second micro-structure extend from a starting point outwards.

In another aspect of the present invention, the plurarity of second micro-structure locate symmetrically at both sides of the first micro-structure which is taken as a symmetrical axle.

In another aspect of the present invention, extending distances of the plurality of second micro-structures are different, and the closer the second micro-structure to the incident side is, the longer extending distance of the second micro-structure is.

In another aspect of the present invention, each micro-structure comprises a plurality of independent structures, and an interval between two of the plurality of independent structure is between 10 μm and 100 μm.

In another aspect of the present invention, each micro-structure extends along a straight line or a curved line.

In another aspect of the present invention, the independent structure of each micro-structure is a triangular or wavy prism.

According to the present invention, a light guide plate comprising a bottom surface and a top surface opposite to the bottom surface is provided. A plurarity of micro-structure units are set up at the bottom surface or the top surface adjacent to an incident side of the light guide plate. Each micro-structure comprises a plurality of micro-structures. Each micro-structure unit comprises a plurality of micro-structures extending divergingly at the bottom surface or the top surface of the light guide plate.

In one aspect of the present invention, each micro-structure unit comprises a first micro-structure and a plurality of second micro-structures which are set up at two sides of the first micro-structure.

In another aspect of the present invention, the first micro-structure and the second micro-structure extend from a starting point outwards.

In another aspect of the present invention, the plurarity of second micro-structure locate symmetrically at both sides of the first micro-structure which is taken as a symmetrical axle.

In another aspect of the present invention, extending distances of the plurality of second micro-structures are different, and the closer the second micro-structure to the incident side is, the longer extending distance of the second micro-structure is.

In another aspect of the present invention, each micro-structure comprises a plurality of independent structures, a width of each micro-structure is between 50 μm and 300 μm, and an interval between two of the plurality of independent structure is between 10 μm and 100 μm.

In another aspect of the present invention, each micro-structure extends along a straight line or a curved line.

In another aspect of the present invention, the independent structure of each micro-structure is a triangular or wavy prism.

According to the present invention, a backlight module comprises a light guide plate and light-source. The light-source is set up at an incident side of the light guide plate correspondingly. The light guide plate comprises a bottom surface and a top surface opposite to the bottom surface, a plurality of micro-structure units are set up adjacently at the top surface or the bottom surface of the incident side. Each micro-structure unit comprises a plurality of micro-structures, and the plurality of micro-structures of each micro-structure unit extend divergingly at the top surface or the bottom surface of the light guide plate.

In one aspect of the present invention, the light-source is a light emitting diode (LED), the LED comprises a plurality of LED chips, and each micro-structure unit corresponds to one of the LED chips.

In another aspect of the present invention, a width of the micro-structure unit is not greater than a distance between two adjacent LED chips.

Comparing to the prior art, the present invention sets up a plurality of micro-structure units adjacently at the top surface or/and bottom surface of lateral side of the light guide plate. Each micro-structure unit comprises a plurality of micro-structures, and a plurality of micro-structures in each micro-structure unit extend diffusely at the top surface or (and) bottom surface of the light guide plate. It is capable of mixing light sufficiently in a shorter distance via the establishment of the light guide plate to attribute the light intensity of the side-light type backlight module even to avoid shadow in the premise of maintaining frame thickness.

### BRIEF DESCRIPTION OF THE DRAWINGS

FIG. 1 shows a diagram of a conventional side-light type backlight module.

FIG. 2 shows a schematic diagram of a conventional side-light type backlight module.

FIG. 3 shows a structure diagram of backlight module according to a first embodiment of the present invention.

FIG. 4 shows an enlarged diagram of a micro-structure unit of a light guide plate according to a second embodiment of the present invention.

FIG. 5 shows an enlarged diagram of a micro-structure unit of a light guide plate according to a third embodiment of the present invention.

FIG. 6 show a cross-sectional view of a micro-structure unit of the light guide plate according to an embodiment of the present invention.

FIG. 7 show a cross-sectional view of a micro-structure unit of the light guide plate according to another embodiment of the present invention.

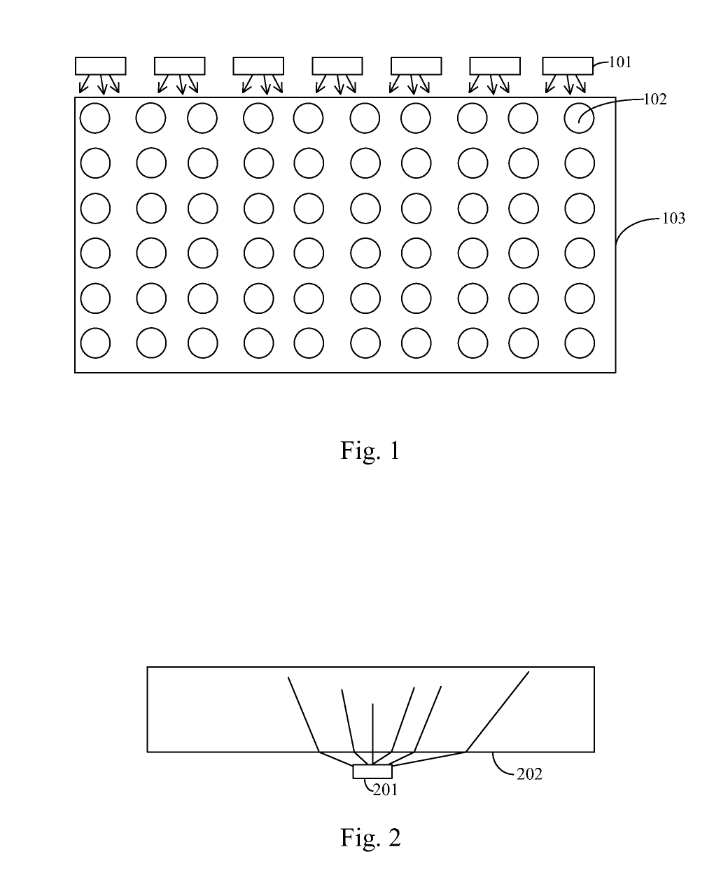

### DETAILED DESCRIPTION OF THE INVENTION

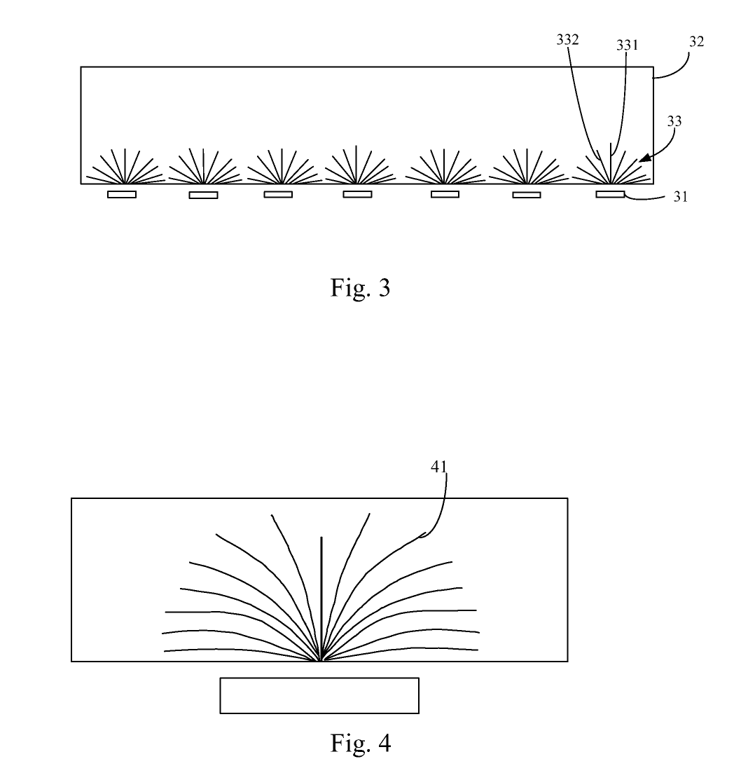

Referring to FIG. 3, FIG. 3 shows a structure diagram of backlight module according to a first embodiment of the present invention. As FIG. 3 illustrates, the backlight module in the embodiment comprises a light source 31 and a light guide plate 32.

In FIG. 3, there are a plurarity of light sources 31 set up at a incident side of the light guide plate 32. The light source 31 using a LED as a light source comprising a plurarity of LED chips. In other embodiments, the light source 31 may be any other illuminating devices.

The light guide plate 32 comprises a bottom surface and a top surface opposite to the bottom surface. At the bottom surface or/and top surface adjacent to the incident side, a plurarity of micro-structure units 33 are set up on the light guide plate 32 one by one. Each micro-structure unit 33 corresponds to a LED chip, and the width of every micro-structure unit 33 is not greater than the distance of adjacent LED chips. Each micro-structure unit 33 comprises a plurality of micro-structures extending divergingly at the bottom surface or/and the top surface of the light guide plate 32. Concretely, each micro-structure unit 33 comprises a first micro-structures 331 and a plurarity of micro-structures 332. The first micro-structure 331 and the plurarity of second micro-structures 332 extend from a starting point, e.g. a center of the corresponding light source 31, outwards. In other embodiments, the starting point can be one of intersections of central lines of the light sources 31 and the borderline of the light guide plate 32. But, in the embodiment, every micro-structure extends straightly. The first micro-structure 331 is perpendicular to the incident surface of the light guide plate 32, while the plurarity of second micro-structure 332 locate symmetrically at both sides of the first micro-structure 331. The micro-structure unit 33 is capable of changing the progress of light so that the light out from the light source 31 can progress and diffuse along with the micro-structures of the micro-structure unit 33 to mingle even in a shorter distance.

Referring to FIG. 4, FIG. 4 shows an enlarged diagram of a micro-structure unit of a light guide plate according to a second embodiment of the present invention. The difference between micro-structure units in FIG. 4 and FIG. 3 lies in the extending pattern of the second micro-structure. As FIG. 4 shows, the second micro-structure 41 extends along curve in the second embodiment. In other embodiments, the second micro-structure 41 is capable of extending more curvely, such as in curve extension.

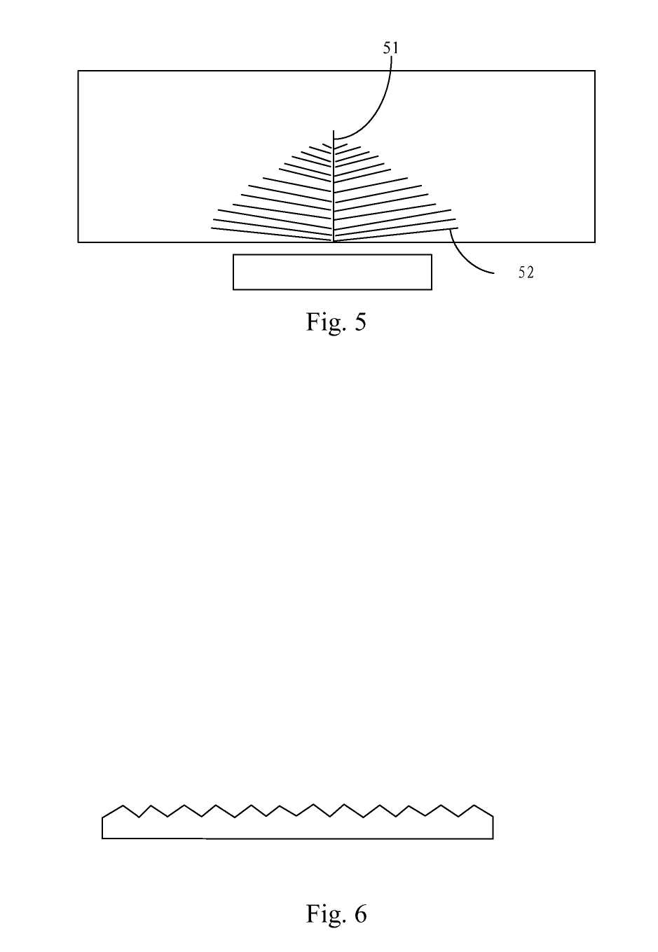

Referring to FIG. 5, FIG. 5 shows an enlarged diagram of a micro-structure unit of a light guide plate according to a third embodiment of the present invention. The difference of the micro-structure unit between FIG. 5 and FIG. 3 and FIG. 4 lies in the starting point and extending length of a second micro-structure 52. Although the second micro-structure 52 extend in straight line, the starting point of the second micro-structure 52 locates differently with those of the first micro-structure 51. Moreover, the closer the second micro-structure 52 to the incident side is, the longer the extension of the second micro-structure 52 is.

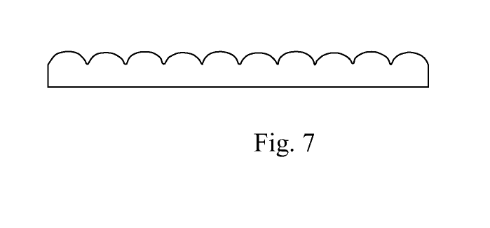

Owing to a prism structure capable of guiding progress of light, the micro-structure of the micro-structure unit 33 is prism. The width of the prism is 50 μm to 300 μm. Each micro-structure comprises a plurality of independent structures. Refer to FIG. 6 and FIG. 7. A profile of a prism of the micro-structure is shaped as a triangle, i.e. each independent structure is shaped as a triangle. Also, a profile of a prism of the micro-structure is wave-shaped, i.e. each independent structure is wave-shaped. An interval between two neighboring independent structures is 10 μm to 100 μm. The profile of the prism of the micro-structure can be another shape in another embodiments. Fabricating methods for micro-structure units 33 comprises heating and pressing, injection molding and tooling, etc.

In sum, a plurarity of micro-structure units 33 are set up at the bottom surface or/and top surface adjacent to the incident side of the light guide plate 32 one by one in the present invention. Each micro-structure unit 33 comprises a plurality of micro-structures extending divergingly at the bottom surface or/and top surface of the light guide plate 32. In the present invention, it is capable of mixing light sufficiently in a shorter distance via such establishment of the light guide plate to attribute the light intensity of the side-light type backlight module even to avoid shadow without raising a frame thickness.

While the present invention has been described in connection with what is considered the most practical and preferred embodiments, it is understood that this invention is not limited to the disclosed embodiments but is intended to cover various arrangements made without departing from the scope of the broadest interpretation of the appended claims.

What is claimed is:

1. A light guide plate comprising a bottom surface and a top surface opposite to the bottom surface, wherein a plurarity of micro-structure units are set up at the bottom surface or the top surface adjacent to an incident side of the light guide plate, each micro-structure comprising a plurality of micro-structures, a width of each micro-structure being between 50 μm and 300 μm, each micro-structure unit comprising a plurality of micro-structures extending divergingly at the bottom surface or the top surface of the light guide plate; wherein each micro-structure unit comprises a first micro-structure and a plurality of second micro-structures which are set up at two sides of the first micro-structure.

2. The light guide plate of claim 1, wherein the first micro-structure and the second micro-structure extend from a starting point outwards.

3. The light guide plate of claim 1, wherein the plurarity of second micro-structure locate symmetrically at both sides of the first micro-structure which is taken as a symmetrical axle.

4. The light guide plate of claim 3, wherein extending distances of the plurality of second micro-structures are different, and the closer the second micro-structure to the incident side is, the longer extending distance of the second micro-structure is.

5. The light guide plate of claim 1, wherein each micro-structure comprises a plurality of independent structures, and an interval between two of the plurality of independent structure is between 10 μm and 100 μm.

6. The light guide plate of claim 5, wherein each micro-structure extends along a straight line or a curved line.

7. The light guide plate of claim 7, wherein the independent structure of each micro-structure is a triangular or wavy prism.

8. A light guide plate comprising a bottom surface and a top surface opposite to the bottom surface, wherein a plurarity of micro-structure units are set up at the bottom surface or the top surface adjacent to an incident side of the light guide plate, each micro-structure comprising a plurality of micro-structures, each micro-structure unit comprising a plurality of micro-structures extending divergingly at the bottom surface or the top surface of the light guide plate.

9. The light guide plate of claim 8, wherein each micro-structure unit comprises a first micro-structure and a plurality of second micro-structures which are set up at two sides of the first micro-structure.

10. The light guide plate of claim 9, wherein the first micro-structure and the second micro-structure extend from a starting point outwards.

11. The light guide plate of claim 9, wherein the plurarity of second micro-structure locate symmetrically at both sides of the first micro-structure which is taken as a symmetrical axle.

12. The light guide plate of claim 11, wherein extending distances of the plurality of second micro-structures are different, and the closer the second micro-structure to the incident side is, the longer extending distance of the second micro-structure is.

13. The light guide plate of claim 8, wherein each micro-structure comprises a plurality of independent structures, a width of each micro-structure is between 50 μm and 300 μm, and an interval between two of the plurality of independent structure is between 10 μm and 100 μm.

14. The light guide plate of claim 8, wherein each micro-structure extends along a straight line or a curved line.

15. The light guide plate of claim 14, wherein the independent structure of each micro-structure is a triangular or wavy prism.

16. A backlight module comprises a light guide plate and light-source, the light-source is set up at an incident side of the light guide plate correspondingly, wherein the light guide plate comprises a bottom surface and a top surface opposite to the bottom surface, a plurality of micro-structure units are set up adjacently at the top surface or the bottom surface of the incident side, each micro-structure unit comprises a plurality of micro-structures, and the plurality of micro-structures of each micro-structure unit extend divergingly at the top surface or the bottom surface of the light guide plate.

17. The backlight module of claim 16, wherein the light-source is a light emitting diode (LED), the LED comprises a plurality of LED chips, and each micro-structure unit corresponds to one of the LED chips.

18. The backlight module of claim 17, wherein a width of the micro-structure unit is not greater than a distance between two adjacent LED chips.
